(19) United States
(12) Patent Application Publication
(10) Pub. No.: US 2015/0244106 A1
(43) Pub. Date: Aug. 27, 2015

(54) CONNECTION TERMINAL

(71) Applicant: Yazaki Corporation, Tokyo (JP)

(72) Inventor: Daisuke MIYAKAWA, Susono-shi (JP)

(73) Assignee: Yazaki Corporation, Tokyo (JP)

(21) Appl. No.: 14/629,981

(22) Filed: Feb. 24, 2015

(30) Foreign Application Priority Data
Feb. 25, 2014 (JP) 2014-034493

(51) Int. Cl. H01R 13/627; H01R 4/20; H01R 13/629

(52) U.S. Cl. CPC H01R 13/6272; H01R 13/629; H01R 4/20

(57) ABSTRACT

A connection terminal includes a terminal body that includes a terminal-connect part provided with a tubular box part having an opening in one end side into which a mating terminal is inserted and a conductor-connect part formed in the other end side of the terminal-connect part. The terminal-connect part and the conductor-connect part are formed integrally by a press work. A functional configuration part is allowed to protrude from and integrally formed with the box part by solid modeling.

### CROSS REFERENCE TO RELATED APPLICATIONS

This application is based upon and claims the benefit of priority of Japanese Patent Application No. 2014-034493 filed on Feb. 25, 2014, the contents of which are incorporated herein by reference in its entirety.

### BACKGROUND OF THE INVENTION

1. Field of the Invention

The present invention relates to a connection terminal.

2. Description of the Related Art

In a connection terminal used for, for instance, an electrical equipment of a motor vehicle, various functional configuration parts are formed. For instance, in a female terminal fitting disclosed in JP-A-2003-243076, the functional configuration part having a reverse-insertion preventing function is provided.

As shown in FIG. 6A, in the female terminal fitting 501, in an upper wall 505 of an electric contact part 503, a guide groove 507 as the functional configuration part which is recessed inward is formed along an axial direction. Thus, the upper wall 505 of the electric contact part 503 and a bottom part 509 are formed so as to have sections which are different from each other. As shown in FIG. 6B, in an upper part 515 of an inner wall of a cavity 513 of a connector housing 511, a guide protruding part 517 is formed which protrudes inward correspondingly to the guide groove 507. When the female terminal fitting 501 is inserted into the cavity 513, the guide groove 507 and the guide protruding part 517 exhibit a reverse-insertion preventing function.

### SUMMARY OF THE INVENTION

However, in an ordinary terminal fitting (refer it simply to as a “terminal”, hereinafter), even when the size of a terminal or the size of an electric wire is the same, there are many kinds of terminals due to a reason of a specification of a manufacturer, an applied place or an applied environment. Accordingly, many press dies need to be manufactured for a blanking or stamping work or a bending work in accordance with many kinds of terminals, so that a production cost is increased. Further, management of parts is complicated because many kinds of terminals exist. Further, in the functional configuration part formed by an embossing work of press metal, a mechanical strength may be hardly obtained. Especially, in the case of a microscopic terminal, it is difficult to ensure the mechanical strength of the functional configuration part.

The present invention is devised by considering the above-described circumstances, and it is a non limited object of the present invention to provide a connection terminal which can reduce kinds of press dies, make terminal parts common and also improve a mechanical strength of a functional configuration part.

A first aspect of the present invention provides a connection terminal including: a terminal body that includes a terminal-connect part provided with a tubular box part having an opening in one end side into which a mating terminal is inserted and a conductor-connect part formed in the other end side of the terminal-connect part, the terminal-connect part and the conductor-connect part being formed integrally by a press work; and a functional configuration part which is allowed to protrude from and integrally formed with the box part by solid modeling.

According to the connection terminal having the first aspect, the terminal body including the terminal-connect part and the conductor-connect part is integrally formed by the press work such as a blanking or stamping work or a bending work from one sheet of metal plate. In the box part of the terminal-connect part, various kinds of different functional configuration parts having different functions are formed afterward by the solid modeling. Namely, the terminal body serves as common parts which can be commonly used to manufacture different kinds of connection terminals. In the box part of the terminal body, various functional configuration parts are allowed to protrude by the solid modeling. As the functional configuration parts which are allowed to protrude from the box part, may be exemplified a lance-engage part, an insertion guide part, a reverse-joint preventing part or the like.

When the functional configuration parts are formed with metal materials, the functional configuration parts are three-dimensionally formed integrally with the box part by the solid modeling such as a powder sintering, laminating and forming method. Namely, the functional configuration parts are additionally formed (what is called, a hybrid forming) to the terminal body. In the functional configuration parts formed in the box part by the solid modeling, connecting parts of the box part and the functional configuration parts are fused to join the functional configuration parts to the box part. When a forming material used in the solid modeling of the functional configuration parts is the same as the metal material of the box part, since the boundary between the box part and the functional configuration part is fused, the functional configuration part can be formed without a joint. For instance, in a connection structure by using a known adhesive agent, the boundary may be possibly peeled off due to a thermal shock. However, in a connection structure by the solid modeling, such a peeling in the interface can be made to hardly arise.

A second aspect of the present invention provides the connection terminal in the first aspect, wherein the functional configuration part includes a wrap-around configuration part which wraps around the box part to be formed over front and back surfaces of the box part.

According to the connection terminal in the second aspect, in the functional configuration part, since the wrap-around configuration part is formed which wraps around the box part to be formed over the front and back surfaces of the box part, the functional configuration part is fixed to the box part due to its form. The wrap-around configuration part can be three-dimensionally formed around an end edge of the box part in the U shape by solid modeling. The wrap-around configuration part can improve a fixed strength of the functional configuration part without applying a work to the box part of the terminal body. Further, the wrap-around configuration part can be three-dimensionally formed integrally with the functional configuration part through a through hole opened in the box part so that the wrap-around configuration part has a form larger than the through hole. The wrap-around configuration part can attach to the box part the functional configuration part having a high reliability which does not fall from the box part.

A third aspect of the present invention provides the connection terminal in the second aspect, wherein the functional configuration part is formed of a resin material.

According to the connection terminal in the third aspect, since the functional configuration part which is three-dimensionally formed in the box part is formed of the resin material, a melting temperature during the solid modeling can be lower than that of the metal material. Thus, a thermal deformation generated in the terminal body can be suppressed. When the functional configuration part is made of a resin, a boundary between the box part and the functional configuration part is joined without being fused to the box part. Accordingly, a mechanical strength is lower than a connection structure that a boundary of metals is fused to each other. However, since in the functional configuration part, the wrap-around configuration part is formed, the functional configuration part can ensure a necessary fixed strength.

According to the connection terminal of the aspects of the present invention, kinds of press dies can be reduced, terminal parts can be made to be common and a mechanical strength of the functional configuration part can be improved.

The present invention is briefly described above. Further, when mode for carrying out the invention (refer it to as an “exemplary embodiment”, hereinafter) which is described below is read by referring to the attached drawings, details of the present invention will be more clarified.

### BRIEF DESCRIPTION OF THE DRAWINGS

In the accompanying drawings:

FIG. 1A is a perspective view of an entire part of a connection terminal according to a first exemplary embodiment of the present invention;

FIG. 1B is a longitudinally sectional view of a terminal-connect part in the connection terminal shown in FIG. 1A;

FIG. 1C is a schematic perspective view showing a forming process of a functional configuration part shown in FIG. 1A;

FIG. 2A is a perspective view of an entire part of a connection terminal according to a second exemplary embodiment of the present invention;

FIG. 2B is a horizontally sectional view of a terminal-connect part in the connection terminal shown in FIG. 2A;

FIG. 2C is a schematic perspective view showing a forming process of a functional configuration part shown in FIG. 2A;

FIG. 3A is a perspective view of an entire part of a connection terminal according to a third exemplary embodiment of the present invention;

FIG. 3B is a longitudinally sectional view of a terminal-connect part in the connection terminal shown in FIG. 3A;

FIG. 3C is a schematic perspective view showing a forming process of a functional configuration part shown in FIG. 3A;

FIG. 4 is a horizontally sectional view of a terminal-connect part according to a modified example to which a functional configuration part having a wrap-around configuration part is attached;

FIG. 5 is a longitudinally sectional view of a terminal-connect part according to another modified example to which a functional configuration part having a wrap-around configuration part is attached;

FIG. 6A is a perspective view of an entire part of a usual female terminal fitting; and

FIG. 6B is a longitudinally sectional view of a connector housing to which the female terminal fitting shown in FIG. 6A is inserted.

### DETAILED DESCRIPTION OF THE EXEMPLARY EMBODIMENTS

Now, exemplary embodiments of the present invention will be described below by referring to the drawings.

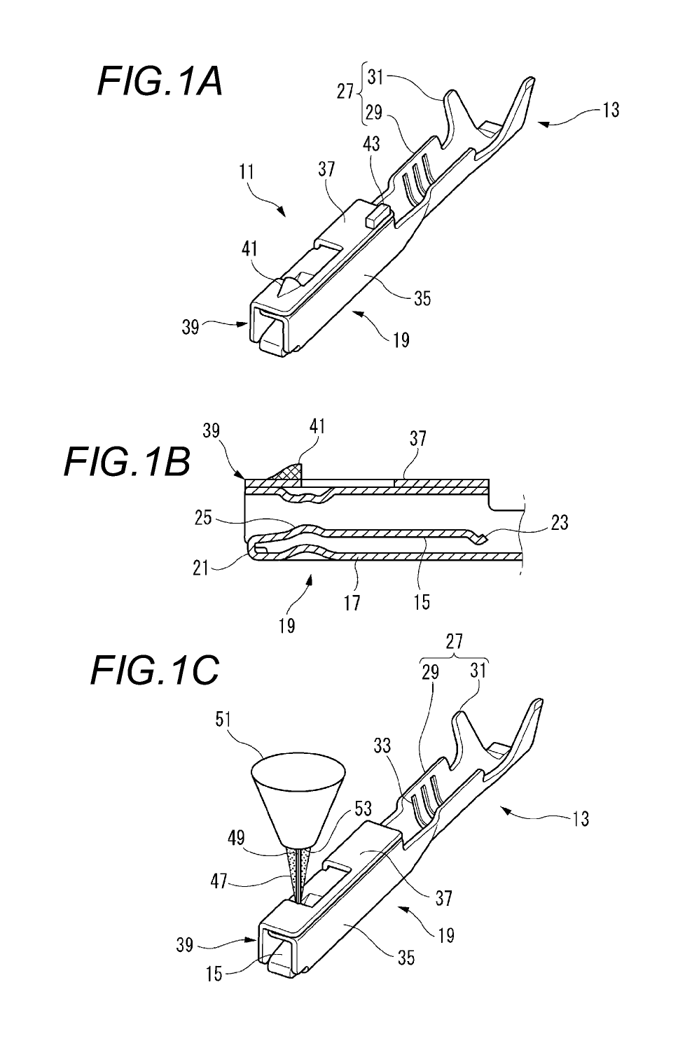

A connection terminal 11 according to a first exemplary embodiment of the present invention is formed with electrically conductive metal and used to be attached to, for instance, a connector housing (not shown in the drawing). The connection terminal 11 includes, as shown in FIG. 1A, a terminal body 13 that has a terminal-connect part 19 provided with a tubular box part 39 having an opening in one end side (the left side in the drawing) into which a mating terminal (not shown in the drawing) is inserted and a conductor-connect part 27 formed in the other end side (the right side in the drawing) of the terminal-connect part 19, which are integrally formed by a press work. The connection terminal 11 also includes a lance-engage part 41 and an insertion guide part 43 as functional configuration parts protruding from and integrally formed with the box part 39 by a solid modeling.

In the terminal body 13, as shown in FIG. 1B, a connection spring part 15 is integrally provided on an upper surface of one end side (the left side in the drawing) of a bottom plate part 17 in a direction along both side edge parts thereof. In the connection spring part 15, a head end part 23 is a free end, and a base end part 21 is bent integrally with the bottom plate part 17. In the connection spring part 15, an indent 25 is allowed to protrude. The connection spring part 15 comes into contact with a male terminal through the indent 25, so that a rise of resistance due to an interposition of insulating powder is suppressed and the connection spring part 15 can continuously come into contact with the male terminal. The connection spring part 15 is electrically conducted and connected to a tab shaped electric contact part of the male terminal (not shown in the drawing) as the mating terminal. Namely, the connection terminal 11 of the first exemplary embodiment is a female terminal.

In the other end side (the right side in the drawing) of the terminal body 13, the conductor-connect part 27 is integrally formed. The conductor-connect part 27 of the first exemplary embodiment includes a conductor crimp part 29 and an insulating coating crimp part 31. The conductor crimp part 29 is crimped to be attached under pressure to a conductor of an electric wire (not shown in the drawing) an insulating coating of which is removed. In the conductor crimp part 29, a serration 33 as serrate notch parts is formed. The serration 33 can remove an oxide film formed by oxidation on the surface of the conductor when the conductor crimp part 29 bites the conductor. In the insulating coating crimp part 31, the electric wire is attached under pressure from an outer periphery of the insulating coating. Thus, the connection terminal 11 is fixed to a terminal of the electric wire.

The box part 39 of the terminal-connect part 19 in the first exemplary embodiment includes the bottom plate part 17, a pair of side plate parts 35 formed to stand upright from both the side edge parts of the one end side of the bottom plate part 17 and a top plate part 37 formed in such a way that upper end edge parts of the one pair of side plate parts 35 are superposed one upon another. The terminal body 13 is formed by the press work such as a blanking or stamping work and a bending work of one sheet of metal plate.

In the box part 39, the lance-engage part 41 and the insertion guide part 43 as the functional configuration parts are allowed to protrude integrally.

The lance-engage part 41 and the insertion guide part 43 of the first exemplary embodiment are made of a metal material and formed integrally with the top plate part 37 of the box part 39 by the solid modeling and protrude outward. The lance-engage part 41 is allowed to protrude in a front part of the top plate part 37 and configured in a form obtained by dividing a conical body into halves along an axial direction. With the lance-engage part 41, a lance formed in a terminal accommodating chamber of the connector housing (an illustration is omitted) is engaged. The connection terminal 11 having the lance-engage part 41 engaged with the lance is restrained from being disengaged from the terminal accommodating chamber. When the connection terminal 11 is inserted into the terminal accommodating chamber, the insertion guide part 43 is fitted to a guide groove (not shown in the drawing) formed in the terminal accommodating chamber to achieve a smooth terminal insertion and a reverse-insertion preventing function.

Here, as the solid modeling, for instance, a powder sintering, laminating and forming method can be used. The powder sintering, laminating and forming method is different from a powder bonding and laminating method in which a binder is applied to material powder to bond and laminate the material powder. In the powder sintering, laminating and forming method, metal and resin powder is successively molten and sintered by a laser heat source and laminated to configure a desired form. In most of other laminating and forming methods as well as an optical forming method, forming materials are limited. As compared therewith, in the powder sintering, laminating and forming method, various forming materials ranging from resin materials to metals or ceramics can be formed.

In the powder sintering, laminating and forming method, as shown in FIG. 1C, metal powder 47 is molten and laminated by a laser heat source in a forming chamber. In the forming chamber, a heating IR heater is provided. In the powder sintering, laminating and forming method, when the material molten by a laser irradiation 49 is suddenly cooled immediately after the molten material is fused to a previously formed layer, a large internal stress is generated between layers. Thus, when a forming environmental temperature is raised near to a melting point of the forming material, a sudden cooling can be suppressed and the internal stress can be prevented from being generated. Further, the forming chamber has a nitrogen atmosphere to prevent combustion or an oxidation.

As laser mounted on a head 51, CO2 laser or YAG laser is used. In addition thereto, in the head 51, a material supply nozzle 53 is provided. An operation of the head 51 is controlled in accordance with 3D CAD data. The head 51 is multi-axis controlled at the same time like a spindle of a machine tool. Further, in the powder sintering, laminating and forming method, since a quantity of the laser irradiation or a quantity of supply of the material is always monitored and controlled, metal layers of precise pitches can be formed without depending on the configuration of a forming surface.

In the powder sintering, laminating and forming method, a hybrid forming can be realized without using an expensive and exclusive alloy, but using an ordinary industrial powder metal alloy. Not only entire part is formed from a base material, but also the functional configuration part such as the lance-engage part 41 or the insertion guide part 43 can be additionally formed in the box part 39. All of the terminal body 13 may be three-dimensionally formed by solid modeling. At the time of an additional forming, the base material (the top plate part 37 of the box part 39) is not limited to a flat surface. The surface of the box part 39 in which the functional configuration part is additionally formed may be a three-dimensional free curved surface such as a cylindrical surface.

In the powder sintering, laminating and forming method, can be used metal such as titanium, stainless steel, nickel alloy, Inconel (registered trademark), aluminum, copper, tin, or the like. In addition thereto, materials such as engineering plastic, ceramics, sand or the like can be selected so as to meet a use.

When the functional configuration part is formed from other non-electrically conductive material than metal by the solid modeling, the solid modeling using the optical forming method can be achieved. For instance, in a manufacturing method by the solid modeling using the optical forming method, ceramics micro-particles such as alumina, silica are blended in photo-setting resin liquid to form a three-dimensionally formed product by the optical forming method. Then, further, the three-dimensionally formed product is sintered, so that a ceramics formed product having a complicated three-dimensional configuration can be manufactured (see JP-A-2006-348214, for instance).

Further, as the solid modeling which manufactures a metal formed product by using metal particles, for instance, a manufacturing method of a three-dimensional metal product (see JP-A-2005-120475, for instance) can be used which includes a step that a particle mixture having a plurality of metals or metal alloy particles and peroxide is accumulated in, for instance, a restricted area and a step that a binder is selectively injected to a prescribed area of the particle mixture by an ink jet method to form an unprocessed part.

Next, a connection terminal 55 according to a second exemplary embodiment of the present invention will be described below. The same component parts of the connection terminal 55 as those of the connection terminal 11 according to the first exemplary embodiment are designated by the same reference numerals and signs, and a detailed description thereof will be omitted.

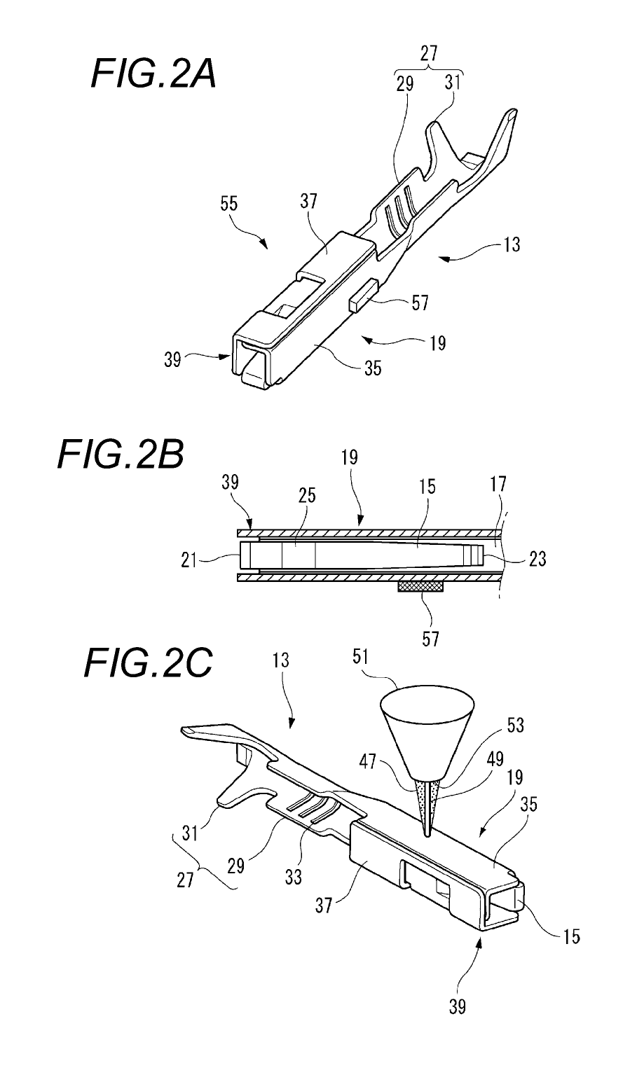

As shown in FIGS. 2A to 2C, the connection terminal 55 according to the second exemplary embodiment has a rectangular parallelepiped shaped reverse-joint preventing part 57 as a functional configuration part which is allowed to protrude from and integrally formed with one of a pair of side plate parts 35 of a box part 39.

The reverse-joint preventing part 57 of the second exemplary embodiment is formed with a metal material and is formed integrally on the side plate part 35 of the box part 39 by, for example, a powder sintering, laminating and forming method as a solid modeling and protrudes outward. When the connection terminal 55 is inserted into a terminal accommodating chamber, the reverse-joint preventing part 57 is fitted to a guide groove formed in the terminal accommodating chamber to achieve a reverse-insertion preventing function.

Subsequently, a connection terminal 59 of a third exemplary embodiment of the present invention will be described below. The same component parts of the connection terminal 59 as those of the connection terminal 11 according to the first exemplary embodiment are designated by the same reference numerals and signs and a detailed description thereof will be omitted.

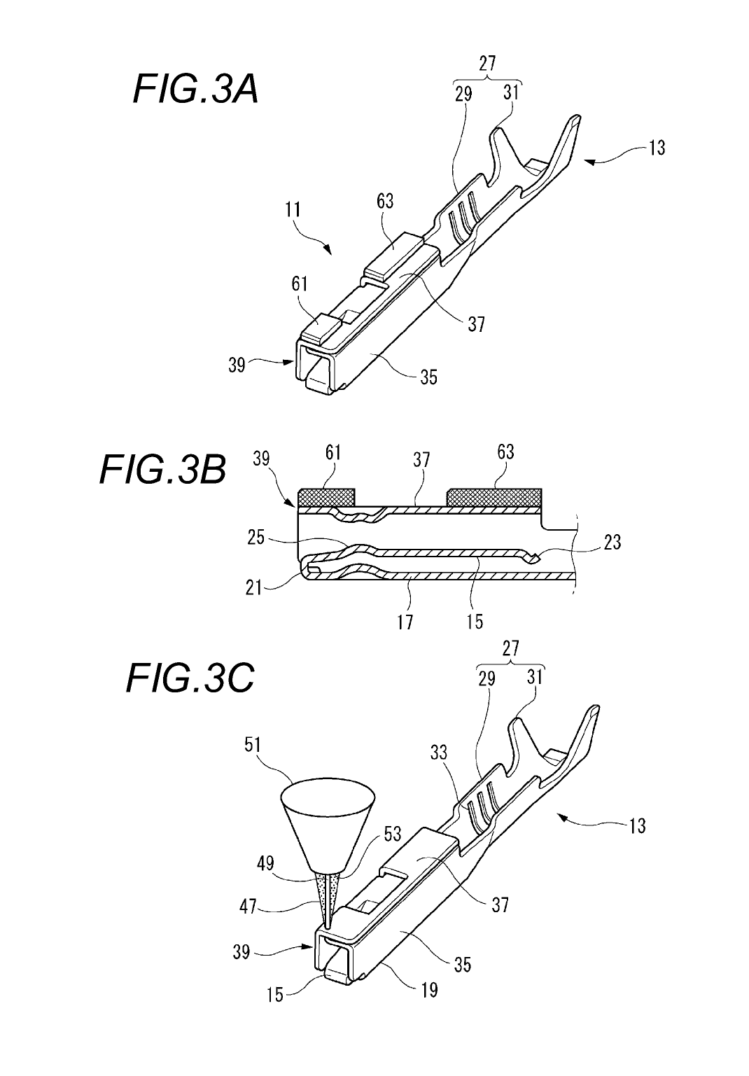

As shown in FIGS. 3A to 3C, a lance-engage part 61 and an insertion guide part 63 as functional configuration parts are allowed to protrude from and integrally formed with a box part 39 of the connection terminal 59 according to the third exemplary embodiment.

The lance-engage part 61 of the third exemplary embodiment is made of a metal material, formed so as to be biased in a direction of width in a front part of a top plate part 37 of the box part 39 and configured in a flat three-dimensional form. With the lance-engage part 61, a retainer or a spacer attached to a connector housing is engaged. The connection terminal 59 having the lance-engage part 61 engaged with the retainer or the spacer as well as a lance is doubly retained from being disengaged from a terminal accommodating chamber. When the connection terminal 59 is inserted into the terminal accommodating chamber, the insertion guide part 63 is fitted to a guide groove formed in the terminal accommodating chamber to achieve a smoother terminal insertion.

Next, operations of the connection terminal 11, the connection terminal 55 and the connection terminal 59 of the first to the third exemplary embodiments which have the above-described structures will be described below.

In the connection terminal 11, the connection terminal 55 and the connection terminal 59 according to the above-described exemplary embodiments respectively, the terminal body 13 having the terminal-connect part 19 and the conductor-connect part 27 is integrally formed by the press work such as the blanking or stamping work or the bending work from the one sheet of metal plate. In the box part 39 of the terminal-connect part 19, various kinds of different functional configuration parts having different functions are formed afterward by the solid modeling. Namely, the terminal body 13 serves as a common parts which can be commonly used to manufacture the different kinds of connection terminals 11, 55 and 59. The lance-engage part 41, the insertion guide part 43, the reverse-joint preventing part 57, the lance-engage part 61 and the insertion guide part 63 which are the various functional configuration parts are allowed to protrude from and integrally formed with the box part 39 by the solid modeling.

When the functional configuration parts are formed with the metal materials, the functional configuration parts are three-dimensionally formed integrally with the box part 39 by the powder sintering, laminating and forming method. Namely, the functional configuration parts are additionally formed (what is called, the hybrid forming) on the terminal body 13. In the functional configuration parts (the lance-engage part 41, the insertion guide part 43, the reverse-joint preventing part 57, the lance-engage part 61, the insertion guide part 63) formed in the box part 39 by the solid modeling, connecting parts of the box part 39 and the functional configuration parts are fused to join the functional configuration parts to the box part. The forming material used in the solid modeling of the functional configuration parts is the same as the metal material of the box part 39. In this case, since a boundary between the box part 39 and the functional configuration part is fused, the functional configuration part can be formed without a joint. For instance, in a connection structure by a known adhesive agent, the boundary may be possibly peeled off due to a thermal shock. However, in a connection structure by the solid modeling, such a peeling in the boundary can be made to hardly arise. As a result, a mechanical strength (a fixed strength) of the functional configuration part can be improved.

According to the solid modeling by the above-described powder sintering, laminating and forming method, even an existing technique can realize a forming accuracy of plus or minus 0.1 mm. Accordingly, a small functional configuration part which is hardly formed by an ordinary blanking or stamping work and a bending work can be formed. Thus, the connection terminal can be more miniaturized.

Next, a connection terminal according to modified examples of the above-described exemplary embodiment will be described below.

The functional configuration parts of the connection terminal 55 and the connection terminal 59 according to the above-described exemplary embodiments may be formed of a resin material by a solid modeling.

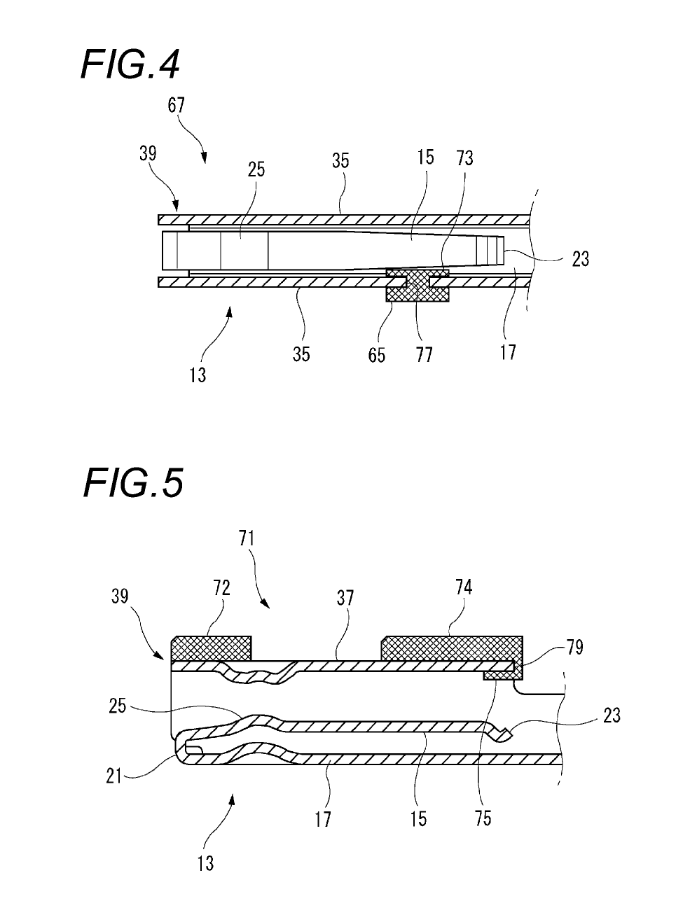

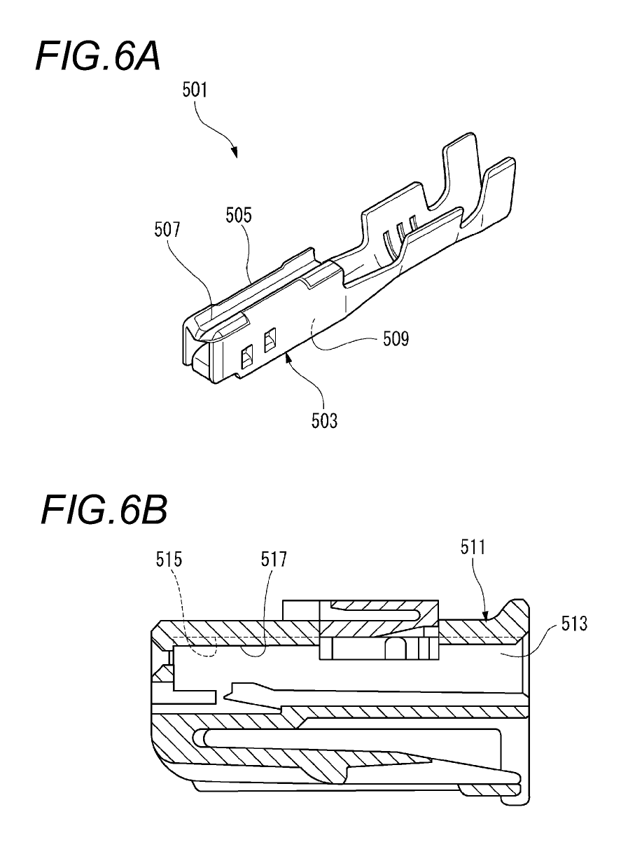

In a connection terminal 67 shown in FIG. 4, a reverse-joint preventing part 65 as a functional configuration part is formed of the resin material. The reverse-joint preventing part 65 has a wrap-around configuration part 73 which wraps around a side plate part 35 to be formed over front and back surfaces of the side plate part 35. In the connection terminal 67, the reverse-joint preventing part 65 is fixed to a box part 39 by the wrap-around configuration part 73.

As shown in FIG. 4, the wrap-around configuration part 73 can be three-dimensionally formed integrally with the reverse-joint preventing part 65 through a through hole 77 opened in the side plate part 35 so that the wrap-around configuration part 73 has a form larger than the through hole 77. The wrap-around configuration part 73 can attach to the box part 39 the reverse-joint preventing part 65 having a high reliability which does not fall from the box part 39.

In a connection terminal 71 shown in FIG. 5, a lance-engage part 72 and an insertion guide part 74 as functional configuration parts are formed of a resin material. The insertion guide part 74 includes a wrap-around configuration part 75 which wraps around a top plate part 37 to be formed over front and back surfaces of the top plate part 37. In the connection terminal 71, the insertion guide part 74 is fixed to a box part 39 by the wrap-around configuration part 75.

As shown in FIG. 5, the wrap-around configuration part 75 can be three-dimensionally formed to wrap around an end edge 79 of a rear part of the top plate part 37 in the U form. The wrap-around configuration part 75 can improve a fixed strength of the insertion guide part 74 without applying a work to the box part 39 of a terminal body 13.

In the connection terminals 67 and 71, the reverse-joint preventing part 65, the lance-engage part 72 and the insertion guide part 74 which are three-dimensionally formed in the box part 39 are made of the resin material. Thus, a melting temperature during the solid modeling can be set to be lower than that of a metal material, so that a thermal deformation generated in the terminal body 13 can be suppressed. When the reverse-joint preventing part 65, the lance-engage part 72 and the insertion guide part 74 are made of a resin, they are joined to the box part 39 without fusing a boundary with the box part 39. Accordingly, a mechanical strength is lower than a connection structure that a boundary of metals is fused to each other. However, since in the reverse-joint preventing part 65 and the insertion guide part 74 as the functional configuration parts, the wrap-around configuration parts 73 and 75 are formed, the reverse-joint preventing part 65 and the insertion guide part 74 can ensure a necessary fixed strength.

In the connection terminal 67 and the connection terminal 71 shown in FIG. 4 and FIG. 5, the reverse-joint preventing part 65 and the insertion guide part 74 which are three-dimensionally formed in the box part 39 are made of the resin material. Alternatively, the functional configuration parts having such wrap-around configuration parts may be three-dimensionally formed from the metal material.

Accordingly, in the connection terminal 11 of the exemplary embodiment of the present invention, kinds of press dies can be reduced, terminal parts can be made to be common and the mechanical strength of the functional configuration part can be improved.

Here, some aspects of the above-described exemplary embodiments of the connection terminal according to the present invention are respectively briefly summarized and listed as described below.

[1] A connection terminal 11 including:

a terminal body 13 that includes a terminal-connect part 19 provided with a tubular box part 39 having an opening in one end side into which a mating terminal is inserted and a conductor-connect part 27 formed in the other end side of the terminal-connect part 19, the terminal-connect part 19 and the conductor-connect part being formed integrally by a press work, and

a functional configuration part (a lance-engage part, an insertion guide part) 41, 43 which is allowed to protrude from and integrally formed with the box part 39 by solid modeling.

[2] The connection terminal 67, 71 according to the configuration [1], wherein the functional configuration part (a reverse-joint preventing part, an insertion guide part) 65, 74 includes a wrap-around configuration part 73, 75 which wraps around the box part 39 to be formed over front and back surfaces of the box part 39.

[3] The connection terminal 67, 71 according to the configuration [2], wherein the functional configuration part (the reverse-joint preventing part, a lance-engage part, the insertion guide part) 65, 72, 74 is formed of a resin material.

The present invention is not limited to the above-described exemplary embodiments, and may be suitably modified and improved. In addition thereto, materials, qualities, forms, dimensions, numbers, arranged positions or the like of component elements in the above-described exemplary embodiments are respectively arbitrary and are not limited as long as they can achieve the present invention.

For instance, in the connection terminals 11, 55 and 59 of the above-described exemplary embodiments, the box part 39 of the terminal-connect part 19 is formed in a configuration of a rectangular tube. However, various forms such as a cylindrical form may be used.

Further, the conductor-connect part 27 of the embodiment is formed by the conductor crimp part 29 and the insulating coating crimp part 31 respectively made of a pair of expanded crimp pieces. However, the conductor-connect part 27 may be formed as a lead part soldered to, for instance, a wiring board or a bus bar.

What is claimed is:

1. A connection terminal comprising:
a terminal body that includes a terminal-connect part provided with a tubular box part having an opening in one end side into which a mating terminal is inserted and a conductor-connect part formed in the other end side of the terminal-connect part, the terminal-connect part and the conductor-connect part being formed integrally by a press work; and
a functional configuration part which is allowed to protrude from and integrally formed with the box part by solid modeling.

2. The connection terminal according to claim 1, wherein the functional configuration part includes a wrap-around configuration part which wraps around the box part to be formed over front and back surfaces of the box part.

3. The connection terminal according to claim 2, wherein the functional configuration part is formed of a resin material.

4. The connection terminal according to claim 1, wherein the functional configuration part includes at least one of a reverse-joint preventing part, an insertion guide part and a lance-engage part.
